(19) United States
(12) Patent Application Publication
(10) Pub. No.: US 2013/0010060 A1
(43) Pub. Date: Jan. 10, 2013

(54) IM Client And Method For Implementing 3D Video Communication

(75) Inventor: Jing LV, Shenzhen City (CN)

(73) Assignee: TENCENT TECHNOLOGY (SHENZHEN) COMPANY LIMITED, Shenzhen City (CN)

(21) Appl. No.: 13/612,265

(22) Filed: Sep. 12, 2012

Related U.S. Application Data
(63) Continuation of application No. PCT/CN2011/071748, filed on Mar. 11, 2011.

(30) Foreign Application Priority Data
Mar. 12, 2010 (CN) 201010123155.6

(51) Int. Cl. H04N 13/00

(52) U.S. Cl. 348/43; 348/51; 348/E13.026; 348/E13.003

(57) ABSTRACT

An Instant Messaging (IM) client and a method for implementing 3D (three-dimensional) video communication. When it is determined that a local video capture device supports 3D video capturing and an opposite side requests to start a 3D video, the 3D video capturing is started. After performing coding on captured 3D video stream according to a preset parameter, a coded 3D video stream is sent. A receiver receives and decodes the coded 3D video stream to display the 3D video.

### CROSS-REFERENCE TO RELATED APPLICATIONS

This application is a continuation of International Application No. PCT/CN2011/071748, filed Mar. 11, 2011. This application claims the benefit and priority of Chinese Application Number 201010123155.6, filed Mar. 12, 2010. The entire disclosures of each of the above applications are incorporated herein by reference.

### FIELD

The present disclosure relates to 3D (three-dimensional) video technology and an Instant Messaging (IM) client and a method for implementing 3D video communication.

### BACKGROUND

This section provides background information related to the present disclosure which is not necessarily prior art.

Along with development of computer technology, images and videos have developed from being two-dimensional to three-dimensional. For audio, in order to generate a spatial relationship where a person's two ears hear different sounds, mono-track is augmented to dual-track. Even surround dimensional sound with 5.1 tracks and 7.1 tracks are implemented with the help of spatial layout of modern sound devices. Similarly, for video, two video cameras at different positions shoot the same scene or one video camera shoots the scene while moving or rotating, using binocular parallax principle of human eyes, two eyes respectively receive left and right images of a certain shooting point of the same scene: a left eye looks at a left image and a right eye looks at a right image, so that binocular parallax is generated, the brain may obtain depth information of the image, and thus the image has strong sense of depth and is vivid. Therefore, users may enjoy strong 3D visual effects.

The 3D video technology relates to 3D video capturing technology, 3D video coding technology and 3D video displaying technology. The 3D video capturing technology is used to capture 3D video images. In order to obtain a 3D video image, two video cameras at different positions shoot the same scene or one video camera shoots the scene through moving or rotating to obtain a 3D image pair, so as to directly simulate a mode of processing scenery by two eyes of a person. The captured two channels of video streams represent image sequences seen by the two eyes of the person respectively. This type of device is usually called a binocular video camera (or a binocular camera).

A 3D video usually has two video channels, and thus data size of the 3D video is significantly greater than that of a single-channel video. Usually, when the 3D video is coded and compressed, besides using relevance within the video channel (a common video coding solution includes intraframe prediction and interframe prediction), the relevance between the two video channels is also used. It is a commonly-used technical means to extract depth information by using 3D images in computer vision field. Michael E. Lukaces is an early researcher of the 3D video coding. Michael E. Lukaces sought to predict one video sequence in 3D video sequences according to the other video sequence in the 3D video sequences by using DC-based, and put forward multiple methods based on the DC-based. The DC-based refers to establishing a corresponding relation between two images by using binocular parallax relation. Franich put forward a method for estimating parallax based on a common block matching algorithm, and introduced a smooth detection means to evaluate parallax matching. Compared with general coding modes, the following solutions are mainly added into the 3D video coding: stationary 3D pair coding, mixed resolution 3D coding, joint-estimation of movement and parallax, object orientation 3D coding, coding compatible with standards, bit distribution based on psychological characteristics, 3D coding based on multi-resolution, multi-view coding and intermediate view synthesis etc. Essentially, the relevance between the binocular video streams is used by all the 3D video coding to wholly improve the coding efficiency of the two channels of video signals.

The 3D video may be watched by wearing a pair of polarized glasses/grating glasses (large screen projection), or may be watched by naked eyes via a special display device (three-dimensional displayer, three-dimensional video mobile phone). Two channels of video streams are projected onto the same screen by using two projectors, and two polarizers are respectively configured in the front of the two projectors, so that light output from the two projectors become polarized light with perpendicular transmission directions. The audience wears the polarized glasses when watching the 3D video and two eyes may respectively receive video images from the two projectors via the polarized glasses, so the parallax is generated and the 3D effect is achieved. When watching the 3D video by polarized glasses, the two channels of video streams are displayed alternately with higher frequency, the first, third and fifth frames display a left sequence; the second, fourth and sixth frames display a right sequence. The polarized glasses controls closing/opening of left and right grating lens through communicating with a display device, so that a left eye may only see the left sequence images of the first, third and fifth frames, a right eye may only see the right sequence images of the second, fourth and sixth frames, and thus the parallax is generated and the 3D effect is achieved. Currently, 3D films in cinemas are usually watched by this mode of using polarized glasses. Similarly, when the 3D video is watched by the naked eyes via the special display device, special materials and veins are used on the surface of the display screen, so that the light respectively gets through the two eyes through refraction, and thus the parallax is generated and the 3D effect is achieved. The above two modes both have advantages and disadvantages. The former has better effects, but it is difficult for common users to have professional devices and a projection field; the latter may obtain better effects only at certain angles because of the limitations, e.g., materials and directions of light refraction, but the users do not need the professional devices, such as a projector, a pair of polarized glasses/grating glasses, etc. The latter has low operating threshold.

Currently, there is no specific solution for implementing the 3D video communication in IM.

### SUMMARY

This section provides a general summary of the disclosure, and is not a comprehensive disclosure of its full scope or all of its features.

In view of the above, the present invention provides an IM client and a method for implementing 3D video communication, so as to implement the 3D video communication in IM.

An IM client for implementing 3D video communication includes:

a signaling parameter controlling module, to receive user command information, input by a user, for starting a 3D video;

a video capturing module, to capture two channels of video streams of a 3D video stream from a video capturing device, and output the two channels of video streams to a video coding module;

the video coding module, to code the two channels of video streams of the 3D video stream according to a preset parameter to obtain a coded 3D video stream; and

a network transmission adapting module, to send the coded 3D video stream.

The IM client further includes a video displaying module, to transmit the two channels of video streams of the 3D video stream to a display device driver interface to display the two channels of video streams of the 3D video stream.

The network transmission adapting module receives a second coded 3D video stream and the IM client further comprises: a video decoding module, to decode the second coded 3D video stream received from the network transmission adapting module to obtain a decoded 3D video stream; and the video displaying module is further to transmit the decoded 3D video stream to the display device driver interface to display the decoded 3D video stream.

The video decoding module decodes single-channel video streams.

The video capturing module captures a single-channel video stream; the video coding module codes the single-channel video stream when a common video mode is used, and sends a coded single-channel video stream to the network transmission adapting module; and the network transmission adapting module sends the coded single-channel video stream.

The video capturing module captures a single-channel video stream. The video coding module codes the single-channel video stream when a common video mode is used, and sends a coded single-channel video stream to the network transmission adapting module; the network transmission adapting module sends the coded single-channel video stream; and the video displaying module is further to transmit the single-channel video stream to the display device driver interface to display the single-channel video stream.

An IM client for implementing 3D video communication includes:

a network transmission adapting module, to receive a coded 3D video stream;

a video decoding module, to decode the coded 3D video stream received from the network transmission adapting module to obtain a decoded 3D video stream; and

a video displaying module, to transmit the decoded 3D video stream to a display device driver interface to display the decoded 3D video stream.

The video decoding module decodes single-channel video streams.

A method for implementing 3D video communication in IM includes: receiving user command information, input by a user, for starting a 3D video; capturing two channels of video streams of a 3D video stream from a video capturing device, and outputting the two channels of video streams to a video coding module; coding the two channels of video streams of the 3D video stream according to a preset parameter to obtain a coded 3D video stream; and sending the coded 3D video stream.

The method further includes: transmitting the two channels of video streams of the 3D video stream to a display device driver interface to display the two channels of the 3D video stream.

The method further includes: receiving a second coded 3D video stream; decoding the second coded 3D video stream to obtain a decoded 3D video stream; transmitting the decoded 3D video stream to the display device driver interface to display the decoded 3D video stream.

The method further includes: capturing a single-channel video stream; coding the single-channel video stream to obtain a coded single-channel video stream when a common video mode is used; and sending the coded single-channel video stream.

The method further includes decoding single-channel video streams.

As may be seen from the above-mentioned technical solutions provided by various embodiments, when it is determined that a local video capturing device supports 3D video capturing and an opposite side requests to start a 3D video, the 3D video capturing is started, after performing coding on captured 3D video stream according to a preset parameter, a coded 3D video stream is sent, a receiver receives and decodes the coded 3D video stream to display the 3D video. In various embodiments, the 3D video communication is implemented in IM; in addition, various embodiments are compatible with conventional common video modes, and takes into account heterogeneous nature of the current network and variety of clients.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating structure of a 3D video communication system;

FIG. 2 is a flowchart illustrating a processing procedure of a sender in a 3D video communication system; and

FIG. 3 is a flowchart illustrating a processing procedure of a receiver in a 3D video communication system.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

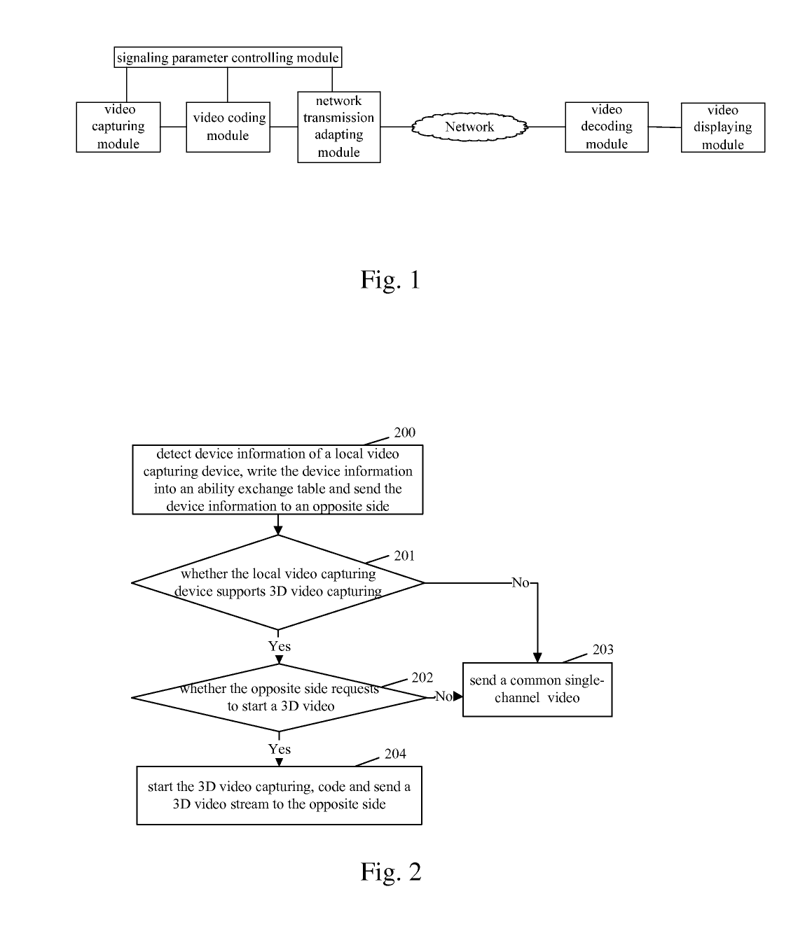

FIG. 1 is a schematic diagram illustrating structure of a 3D video communication system of the present invention. As shown in FIG. 1, the system includes a signaling parameter controlling module, a video capturing module, a video coding module, a network transmission adapting module, and a video displaying module.

The signaling parameter controlling module is adapted to interact with commands input by a user, notify corresponding modules of user command information, e.g., starting a 3D video.

The video capturing module communicates with a video capturing device and is adapted to receive the user command information for starting the 3D video, which indicates capturing two channels of video streams (a dual-channel video stream) from the video capturing device, e.g., a binocular camera. The video capturing module uses a 3D video communication mode, marking left and right properties, widths, heights and formats of the two channels of video streams, and outputs the two channels of video streams to the video coding module. The video capturing module is further adapted to capture a single-channel common video stream and output the single-channel common video stream to the video coding module.

The video coding module is adapted to receive the user command information for starting a 3D video, code a 3D video stream according to a preset parameter, and output a coded 3D video stream to the network transmission adapting module. After receiving a notification of starting the 3D video, which indicates that through a 3D video communication mode, the 3D video coding module codes the dual-channel video stream by using a 3D video coding compression method. The specific 3D video coding mode is not limited here. For example, the two channels of video streams are marked as a main sequence and an auxiliary sequence, and the main sequence is coded by using a universal video coding mode. Besides using an intraframe prediction mode and an interframe prediction mode in the universal video coding mode, a prediction mode of parallax estimation compensation is added, i.e., to perform parallax estimation compensation coding on the auxiliary sequence by using a corresponding frame of the main sequence as a reference frame. Further, the video coding module is also adapted to code the single-channel video stream when the common video mode is used, and output a coded single-channel common video stream to the network transmission adapting module.

The network transmission adapting module is adapted to receive the user command information for starting the 3D video and send the coded 3D video stream. When the 3D video coding mode is used, a relevance sending strategy is applied for corresponding frames of the main sequence and the auxiliary sequence to ensure that time-synchronous frames are received at the same time and to avoid reducing experiences of users. The network transmission adapting module is also adapted to send the common coded video stream by using an anti-packet-loss strategy or a buffer strategy and so on. The mentioned relevance sending strategy, anti-packet-loss strategy, and buffer strategy are commonly-used technical means known to one skilled in the art, and are not described herein.

The video displaying module, communicated with a display device, is adapted to transmit the 3D video stream to a display device driver interface to display the 3D video stream. Further, the video displaying module is also adapted to transmit the single-channel video stream to the display device driver interface to display the single-channel video stream.

FIG. 1 shows structure of a 3D video communication system in a one-way video communication. In various applications, any one of IM clients may be a sender or a receiver and may perform full-duplex communication. Communication links of the uplink and downlink are independent, which are well known to one skilled in the art. For example, the receiver includes a video decoding module adapted to receive a notification of switching to a 3D video communication from a user and decodes the 3D video stream received from the network transmission adapting module. Further, the video decoding module is also adapted to decode a common video stream.

FIG. 2 is a flowchart illustrating a processing procedure of a sender in a 3D video communication system. As shown in FIG. 2, the following blocks are included.

Block 200: preparation for ability exchange, i.e., a video capturing module detects device information of a local video capturing device and sends the device information to a receiver of an opposite side. In this block, the detection is determined according to video stream formats supported by a camera hardware driver. The device information of the local video capturing device includes supported video stream formats, single-channel capturing or two-channel capturing, specific video frame format parameters, and capturing frame rate etc.

Block 201: it is determined whether the local video capturing device supports 3D video capturing or not. If the local video capturing device does not support the 3D video capturing, block 203 is performed. If the local video capturing device supports the 3D video capturing, block 202 is performed. In this block, the determining includes: if the device information indicates that the single-channel capturing is supported, it is determined that the 3D video capturing is not supported. If the device information indicates that the two-channel capturing is supported, it is determined that the 3D video capturing is supported.

Block 202: it is determined whether the receiver of the opposite side requests to start a 3D video. If there is not a request, block 203 is performed. If a signaling notification for starting the 3D video is received from the opposite side, block 204 is performed.

Block 203: a single-channel common video is sent, data is coded according to a common video mode, and the procedure is terminated.

Block 204: the 3D video capturing is started, and a 3D video stream is coded and sent to the opposite side. The following processes are included in this block: receiving a signaling for starting the 3D video from the opposite side, starting capturing two channels of videos, coding data of the captured two channels of videos by using a dual-channel 3D video coding mode, performing redundancy control according to a packet loss rate, and performing relating sending for the corresponding two frames, so as to ensure that binocular corresponding frames can arrive at the same time and avoid loss of some parts.

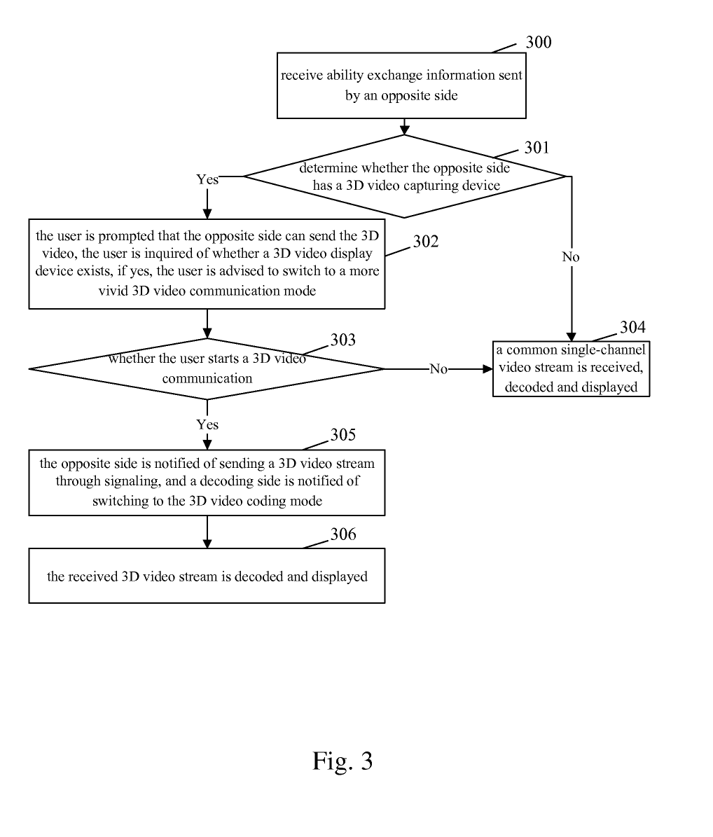

FIG. 3 is a flowchart illustrating a processing procedure of a receiver in a 3D video communication system. As shown in FIG. 3, the following blocks are included.

Blocks 300-301: a receiver receives ability exchange information sent by an opposite side, and determines whether the opposite side has a video capturing device which supports 3D video capturing. If the opposite side has the video capturing device, block 302 is performed, otherwise, block 304 is performed.

Blocks 302-303: when the opposite side supports the 3D video capturing, the receiver first detects whether a user has a 3D video display device;

If it is detected that the user has the 3D video display device, the user is prompted to determine whether to switch to a 3D video communication. When the user determines to switch to the 3D video communication, block 305 is performed, otherwise, block 304 is performed;

If it is detected that the user does not have the 3D video display device, block 304 is performed without any prompt for the user;

If the detection fails, the user is asked whether a 3D video display device exists. If the 3D video display device exists, the user is advised to switch to a more vivid 3D video communication mode, and block 305 is performed when the user selects to switch to the 3D video communication, otherwise, block 304 is performed.

Block 304: a single-channel video stream is received, decoded and displayed. The procedure is terminated.

Block 305: after the user selects to switch to the 3D video communication mode, the opposite side is notified through signaling to send a 3D video stream, and a decoding side is notified to switch to a 3D video decoding mode.

Block 306: the received 3D video stream is decoded and displayed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An Instant Messaging, IM, client for implementing three-dimensional, 3D, video communication, comprising:
a signaling parameter controlling module, to receive user command information, input by a user, for starting a 3D video;
a video capturing module, to capture two channels of video streams of a 3D video stream from a video capturing device, and output the two channels of video streams to a video coding module;
the video coding module, to code the two channels of video streams of the 3D video stream according to a preset parameter to obtain a coded 3D video stream; and
a network transmission adapting module, to send the coded 3D video stream.

2. The IM client of claim 1, further comprising:
a video displaying module, to transmit the two channels of video streams of the 3D video stream to a display device driver interface to display the two channels of video streams of the 3D video stream.

3. The IM client of claim 2, wherein the network transmission adapting module is further to receive a second coded 3D video stream;
the IM client further comprises: a video decoding module, to decode the second coded 3D video stream received from the network transmission adapting module to obtain a decoded 3D video stream; and
the video displaying module is further to transmit the decoded 3D video stream to the display device driver interface to display the decoded 3D video stream.

4. The IM client of claim 3, wherein the video decoding module is further to decode single-channel video streams.

5. The IM client of claim 1, wherein
the video capturing module is further to capture a single-channel video stream;
the video coding module is further to code the single-channel video stream when a common video mode is used, and send a coded single-channel video stream to the network transmission adapting module; and
the network transmission adapting module is further to send the coded single-channel video stream.

6. The IM client of claim 2, wherein
the video capturing module is further to capture a single-channel video stream;
the video coding module is further to code the single-channel video stream when a common video mode is used, and send a coded single-channel video stream to the network transmission adapting module;
the network transmission adapting module is further to send the coded single-channel video stream; and
the video displaying module is further to transmit the single-channel video stream to the display device driver interface to display the single-channel video stream.

7. An IM client for implementing three-dimensional, 3D, video communication, comprising:
a network transmission adapting module, to receive a coded 3D video stream;
a video decoding module, to decode the coded 3D video stream received from the network transmission adapting module to obtain a decoded 3D video stream; and
a video displaying module, to transmit the decoded 3D video stream to a display device driver interface to display the decoded 3D video stream.

8. The IM client of claim 7, wherein the video decoding module is further to decode single-channel video streams.

9. A method for implementing 3D video communication in Instant Messaging, IM, comprising:
receiving user command information, input by a user, for starting a 3D video;
capturing two channels of video streams of a 3D video stream from a video capturing device, and output the two channels of video streams to a video coding module;
coding the two channels of video streams of the 3D video stream according to a preset parameter to obtain a coded 3D video stream; and
sending the coded 3D video stream.

10. The method of claim 9, further comprising:
transmitting the two channels of video streams of the 3D video stream to a display device driver interface to display the two channels of the 3D video stream.

11. The method of claim 10, further comprising:
receiving a second coded 3D video stream;
decoding the second coded 3D video stream to obtain a decoded 3D video stream;
transmit the decoded 3D video stream to the display device driver interface to display the decoded 3D video stream.

12. The method of claim 11, further comprising:
capturing a single-channel video stream;
coding the single-channel video stream to obtain a coded single-channel video stream when a common video mode is used; and
sending the coded single-channel video stream.

13. The method of claim 11, further comprising: decoding single-channel video streams.
